(19) United States
(12) Patent Application Publication
(10) Pub. No.: US 2026/0267456 A1
(43) Pub. Date: Sep. 10, 2026

(54) AN INTRAORAL SCANNER SYSTEM WITH A DIGITAL MOVABLE ITEM AND A METHOD FOR CONTROLLING AN APPEARANCE OF THE DIGITAL MOVABLE ITEM

(71) Applicant: 3SHAPE A/S, Copenhagen K (DK)

(72) Inventor: Simon HOFFGAARD, Copenhagen K (DK)

(73) Assignee: 3SHAPE A/S, Copenhagen K (DK)

(21) Appl. No.: 19/491,292

(22) PCT Filed: Jun. 10, 2024
(86) PCT No.: PCT/EP2024/065907

§ 371 Date: Dec. 8, 2025

(30) Foreign Application Priority Data
Jun. 9, 2023 (DK) PA 2023 70280

(51) Int. Cl. G06F 3/04812; A61C 9/00; G06F 3/0346; G06F 3/04815; G06F 3/04845; G06T 17/00; G06T 19/20

(52) U.S. Cl. CPC G06F 3/04812; A61C 9/006; G06F 3/0346; G06F 3/04815; G06F 3/04845; G06T 17/00; G06T 19/20; G06T 2200/24; G06T 2210/41; G06T 2219/2016

(57) ABSTRACT

An intraoral scanner system includes a handheld intraoral scanner, one or more processors, and a graphical user interface. The one or more processors is configured to change an appearance of a digital movable item displayed in the graphical user interface, to reflect an instruction to modify an orientation or design of a digital 3D model of a dental object displayed in the graphical user interface, included in a digital element of one or more digital elements displayed in the graphical user interface, when the digital movable item is positioned over the digital element of the one or more digital elements. A method is provided for performing the change of the appearance of the digital movable item.

### FIELD

The disclosure relates to an intraoral scanner system with a digital movable item that is adaptable in appearance to assist a user of the intraoral scanner system and a method for controlling the appearance of the digital movable item. In particular, the disclosure relates to a digital movable item (e.g. a cursor) displayed in a graphical user interface of the system, that is wirelessly controlled by a handheld intraoral scanner of the system and that is configured to change appearance to indicate an action to be performed if a user interface of the handheld intraoral scanner is activated.

### BACKGROUND

When scanning teeth of a patient using a handheld intraoral scanner, it is important that the handheld intraoral scanner used is kept away from getting into contact with surfaces, other than what is necessary for the scan to be performed, such as surfaces of other equipment, surfaces of devices, surfaces of clothes, or surfaces of other body parts than the teeth that are to be scanned. This is to ensure, that the handheld intraoral scanner doesn't get contaminated, or, that the handheld intraoral scanner that already has been contaminated doesn't contaminate other surfaces.

The dental practitioner may however want to control a process of a scan or adjust parameters during the scan and may therefore need to use other devices, such as a computer mouse or a touch screen, while performing the scan.

Placing the handheld intraoral scanner on a holder, cleaning the hands or removing sanitary gloves, performing the control or adjustment on the other devices, and subsequently cleaning the hands again or wearing new sanitary gloves, is a cumbersome and time-demanding process. Therefore, a handheld intraoral scanner with the capability to control movements of a digital movable item (e.g. a cursor) remotely is more ideal if wanting to avoid the repeatedly cleaning of the hands during a scanning of a patient.

However, remotely controlling a digital movable item (e.g. cursor) on a graphical user interface using a handheld intraoral scanner may for some dental practitioners be difficult to identify due to the distant between a display unit that displays the graphical user interface and the dental practitioner performing the scanning of a patient. To overcome this issue, the digital movable item (e.g. a cursor) is designed relatively large such that it can be seen from distant, however, it has been experienced that the relatively large icon hinders the dental practitioner in viewing a digital element in the graphical user interface that the dental practitioner wishes to select. Other operations in the graphical user interface, such as trimming of a digital 3D model of a dental object, may require relatively precise actions, and may be difficult using a relatively large digital movable item.

### SUMMARY

An aspect of the present disclosure is to provide an intraoral scanner system that is configured to change an appearance of a digital movable item (e.g. a cursor) when at least partly positioned over a digital element on a graphical user interface, that is configured to display a digital 3D model of a dental object. The intraoral scanner system may be configured to change the appearance of the digital movable item to reflect an instruction to be applied, when the digital element is selected using a handheld intraoral scanner that is configured to remotely control the digital movable item in the graphical user interface.

Changing the appearance of at least a part of the digital movable item to reflect an instruction of the digital element would improve a guidance or an assisting of the user in selecting the correct digital element of the one or more digital elements. A user of the intraoral scanner who would otherwise not be able to view a selectable digital element in the graphical user interface would be able to view a digital element due to the changing of shape and transparency of the digital movable item. For example, the digital movable item may become smaller in size or transparent when approaching a digital element. In another example, the appearance of the digital movable item may mimic the digital element that the digital movable item is closest to or overlapping in the graphical user interface, and thereby, the digital element becomes indirectly visible. A user of the system may be standing at a distance from the graphical user interface that may not allow the user to have a clear view of the details of the graphical user interface, and thus not able to distinguish the digital elements in the graphical user interface. In such a situation, the system is further beneficial as the digital movable item may increase in size when positioned over a digital element and at the same time may change appearance to reflect the instruction of the digital element. The system allows an increased accessibility, guiding, or assisting of the user of the intraoral scanner system.

In a situation where a computer mouse may be used for moving around the digital movable item, the user would be located within a range to a display unit that allows the user to easily see the digital movable item and the one or more digital elements on the graphical user interface because of the short communication range of the computer mouse. Therefore, the user would not face similar problems as if the user is in a scanning situation and is located distantly to the graphical user interface.

According to the aspect an intraoral scanner system is provided. The system may be configured to display a digital 3D model of a dental object. The system may comprise a handheld intraoral scanner that may be configured to obtain light information reflected from a dental object. The dental object may be a tooth, a part of a tooth, an upper jaw or a lower jaw or parts thereof, an entire dentition, a gingiva, or part of the gingiva. The handheld intraoral scanner may be configured to emit light such as visible light, infrared light, or near-infrared light, from a light source such as an LED (light emitting diode), inside the handheld intraoral scanner.

The handheld intraoral scanner may comprise one or more light projectors configured to generate an illumination pattern to be projected on a three-dimensional dental object during a scanning session. The light projector(s) may comprise a light source, a mask having a spatial pattern, and one or more lenses such as collimation lenses or projection lenses. The light source may be configured to generate light of a single wavelength or a combination of wavelengths (mono-or polychromatic). The combination of wavelengths may be produced by using a light source configured to produce light (such as white light) comprising different wavelengths. Alternatively, the light projector(s) may comprise multiple light sources such as LEDs individually producing light of different wavelengths (such as red, green, and blue) that may be combined to form light comprising the different wavelengths. Thus, the light produced by the light source may be defined by a wavelength defining a specific colour, or a range of different wavelengths defining a combination of colours such as white light. In an embodiment, the scanning device comprises a light source configured for exciting fluorescent material of the teeth to obtain fluorescence data from the dental object. Such a light source may be configured to produce a narrow range of wavelengths. In another embodiment, the light from the light source is infrared (IR) light, which is capable of penetrating dental tissue. The light projector(s) may be DLP projectors using a micro mirror array for generating a time varying pattern, or a diffractive optical element (DOF), or back-lit mask projectors, wherein the light source is placed behind a mask having a spatial pattern, whereby the light projected on the surface of the dental object is patterned. The back-lit mask projector may comprise a collimation lens for collimating the light from the light source, said collimation lens being placed between the light source and the mask. The mask may have a checkerboard pattern, such that the generated illumination pattern is a checkerboard pattern. Alternatively, the mask may feature other patterns such as lines or dots, etc.

The handheld intraoral scanner may be configured to obtain the light information reflected from the dental object by the use of an image sensor arranged within the handheld intraoral scanner. The light information may be scan data, such as intraoral scan data. The light information may be intraoral scan data that may include two-dimensional information about the dental object. The two-dimensional information may include geometric information and may include colour information. The two-dimensional information may include fluorescens information. Fluorescens information may be obtained by the handheld intraoral scanner comprising a light source that is configured to excite fluorescent material of the teeth to obtain the fluorescence information. Fluorescence information may be used to diagnostics of diseases related to the dental object, such as the tooth. Such a light source may be configured to produce a narrow range of wavelengths. Light from the light source may be infrared (IR) light or near-infrared (NIR) light, which is capable of penetrating dental tissue. Penetrating the dental tissue by the infrared light may provide information about the dental tissue which may be an inner region of the dental object, such as the dentin or inner regions of the gingiva. The light information reflected from the dental object in response to the illumination of the dental object, that may include geometry information and/or colour information related to the dental object, is directed, using optical components of the handheld intraoral scanner, towards one or more image sensors. The image sensor(s) of the handheld intraoral scanner may be configured to generate a plurality of images based on the incoming light information received from the illuminated dental object. The handheld intraoral scanner comprises one or more image sensors, wherein said image sensors are configured for acquiring a set of images. The set of images may comprise a plurality of two-dimensional (2D) images, such as one image per image sensor of the one or more image sensors. The one or more image sensors may be configured for acquiring the images within the set of images approximately simultaneously. As an example, the handheld intraoral scanner may comprise four or more image sensors configured to acquire the set of images. The handheld intraoral scanner may further comprise one or more processors configured for generating a digital 3D model of at least a part of the dental object, wherein the digital 3D model is generated based on the set of images. As an example, the digital 3D model may be generated by triangulation of determined image features in the images within a given set of images.

The image sensor(s) may be a very high-speed image sensor such as an image sensor configured for acquiring images with exposures of less than 1/1000 second or frame rates in excess of 250 frames pr. Second (fps) for 2D images and for 3D sub scans. The image sensor(s) may be a high-speed image sensor with frame rates in excess of 50 frames per second. As an example, the image sensor(s) may be a rolling shutter or a global shutter sensor. As an example, the image sensor(s) may be a CMOS sensor. The image sensor(s) may be a monochrome sensor including a colour filter array such as a Bayer filter and/or additional filters that may be configured to substantially remove one or more colour components from the reflected light information and retain only the other non-removed components prior to conversion of the reflected light information into an electrical signal. For example, such additional filters may be used to remove a certain part of a white light spectrum, such as a blue component, and retain only red and green components from a signal generated in response to exciting fluorescent material of the teeth. Furthermore, such additional filters may be used to remove wavelength components that corresponds to infrared. The intraoral scanner system may comprise one or more processors. The one or more processors may be operably connected to the handheld intraoral scanner. The one or more processors may be configured to determine, in real time, surface information from the light information, and generate a digital 3D model (e.g. a three-dimensional surface model) of the dental object using the surface information. The one or more processors may be configured to process the light information into a digital 3D model of the dental object.

The one or more processors may comprise one processor, such as a CPU (central processing unit), with one or more processor cores. The one or more processors may comprise more than one processor, such as a plurality of CPUs, such as a processing cluster, wherein each of the plurality of CPUs includes one or more processor cores. The handheld intraoral scanner and the one or more processors may be separate entities, which may allow the processing of the light information or intraoral scan data to occur outside the intraoral scanner and may thus allow for using remote resources or may allow for a cloud-based processing.

All or some of the one or more processors may thus be arranged inside the handheld intraoral scanner, inside a laptop computer, a desktop computer, a tablet, a smartphone, or a smart display unit. All or partly of the one or more processors may be arranged remotely in a remote server, such as a cloud-based server that is operably connected to the handheld intraoral scanner by a cable or by a wireless connection. The one or more processors may further be distributed between two or more of the above mentioned arrangements. For example, some of the one or more processors may be located in the handheld intraoral scanner in the form of a CPU (central processing unit), while some other of the one or more processors may be located in a computer that is located in vicinity to the handheld intraoral scanner. The computer and the handheld intraoral scanner may be in a same clinic, and while yet some other of the one or more processors may be located in a remote server, and connected to the handheld intraoral scanner or to the desktop computer via the internet.

The intraoral scanner system may comprise a graphical user interface. The graphical user interface may be displayed on a display unit of the intraoral scanner system. The display unit may be a laptop screen, a tablet screen, a smartphone, or a computer screen. The graphical user interface may be controlled by the one or more processors. The graphical user interface may be configured to display the digital 3D model, a digital movable item, and one or more digital elements, such as icons, digital buttons, etc. The digital movable item may be a cursor.

The handheld intraoral scanner may include a motion sensor. The motion sensor may comprise a gyroscope and/or an accelerometer. The gyroscope may provide information that relates to an orientation of the handheld intraoral scanner. The accelerometer may provide information that relates to a movement of the handheld intraoral scanner. The motion sensor may be configured to provide a motion signal that relates to an orientation and/or a movement of the handheld intraoral scanner from the gyroscope and the accelerometer, respectively.

The one or more processors may be configured to receive the motion signal from the motion sensor. The one or more processors may be configured to control a movement of the digital movable item based on the motion signal. The one or more processors may be configured to receive a motion signal from the motion sensor in real-time and process the received motion signals to obtain real-time information about an orientation and/or a movement of the handheld intraoral scanner. The one or more processors may be configured to translate a physical movement of the handheld intraoral scanner to a digital movement of the digital movable item in the graphical user interface. The one or more processors may for example receive a motion signal with information that the handheld intraoral scanner has moved to the right, and the one or more processors may subsequently move the digital movable item (e.g. a cursor) to the right.

Each of the one or more digital elements may include an instruction to modify a position or a design of the digital 3D model. The position may include an orientation or a location of the digital 3D model on the graphical user interface. The instruction of each of the one or more digital elements may be stored in a data store of the intraoral scanner system, such as in a memory of a computer, a tablet, or a server, that may be operatively connected to the intraoral scanner system. The instruction may be any orientation, modification, or visualization operation known in the art, such as, but not limited to, a moving, rotating, extending, trimming, zooming, capturing an instant image, copying, selecting, drawing, adding information, or changing colour. The one or more processors may be configured to apply the instruction to the digital 3D model, when a respective digital element of the one or more digital elements has been selected. The digital element of the one or more digital elements may be selected by interaction with a user interface of the handheld intraoral scanner while the digital movable item is positioned over the digital element of the one or more digital elements in the graphical user interface. The user interface of the handheld intraoral scanner may comprise a digital or a physical button. The interaction may be facilitated by the user interface of the handheld intraoral scanner. If the digital moveable item is located at least partly over a digital element in the graphical user interface and the user interacts with the user interface of the handheld intraoral scanner, the one or more processors may then be configured to apply an instruction that corresponds to the digital element of the one or more digital elements to the digital 3D model. The applying of the instruction to the digital element may result in a change of an appearance of the digital movable item that mimics the instruction.

Changing the appearance of at least a part of the digital movable item to reflect an instruction of the digital element would improve a guidance or an assisting of the user in selecting the correct digital element of the one or more digital elements. A user of the intraoral scanner who would otherwise not be able to view a selectable digital element in the graphical user interface would be able to view a digital element due to the changing of shape and transparency of the digital movable item. For example, the digital movable item may become smaller in size or transparent when approaching a digital element. In another example, the appearance of the digital movable item may mimic the digital element that the digital movable item is closest to or overlapping in the graphical user interface, and thereby, the digital element becomes indirectly visible. A user of the system may be standing at a distance from the graphical user interface that may not allow the user to have a clear view of the details of the graphical user interface, and thus not able to distinguish the digital elements in the graphical user interface. In such a situation, the system is further beneficial as the digital movable item may increase in size when positioned over a digital element and at the same time may change appearance to reflect the instruction of the digital element. The system allows an increased accessibility, guiding, or assisting of the user of the intraoral scanner system.

At least a part of the digital movable item may be configured to change the appearance when being at a position over or moved towards a digital element of the one or more digital elements. The one or more processors may be configured to change the appearance of the digital movable item. The appearance may reflect the instruction of the digital element of the one or more digital elements. The one or more processors may be configured to obtain information about the instruction and change the appearance of the digital movable item to reflect the instruction. The one or more processors may be configured to change the appearance of the digital movable item into a shape (e.g. copying the shape of the digital element or an image of the digital element), a content (e.g. changing an image or icon that reflects the instruction of the digital element), a colour, transparency, size, or add dynamics (e.g. mimicking a function of the instruction) or information (e.g. text, numbers, symbols). The instruction may comprise information to change an appearance of the digital movable item, when the digital movable item is moved over or towards the digital element comprising the instruction. The instruction may comprise information to modify an orientation and/or a design of the digital 3D model, and information to change an appearance of the digital movable item, when the digital movable item is moved over or towards the digital element comprising the instruction.

For example, if the digital element of the one or more digital elements is a trimming or cutting tool, the digital movable item, when at least partly moved over the digital element:
may change shape into a scissor;
may change content into comprising an image of a scissor;
may become at least partly transparent such that the digital element of the one or more digital elements is at least partly visible under or behind the digital movable item;
may become smaller, such that the digital element of the one or more digital elements becomes at least partly visible; or
may move in a dynamic pattern mimicking the pattern of a cutting scissor, and/or showing a text with the letters “scissor” or “cut”.

If the selected digital element of the one or more digital elements comprises an instruction to perform a cut in the digital 3D model, the digital movable item may change appearance to mimic a scissor or to a circle of a default size, which may be the standard size that may be a predefined size, and may be configured to perform cuts in the digital 3D model according to the default size.

If the digital movable item is positioned over a digital element of the one or more digital elements that comprises an instruction to perform smaller cuts in the digital 3D model than the default cut size, the digital movable item may become smaller, indicating that if this digital element is selected, a smaller cut may be enabled.

In another example, if a selected digital element of the one or more digital elements comprises an instruction for adding a colour, the digital movable item may change it's colour into the colour of the instruction of the digital element of the one or more digital elements. In yet another example, the digital movable item may change the size and the shape into a scissor. The user of the handheld intraoral scanner who is viewing the graphical user interface from a distance, will get an improved visibility to what may occur, when a user interface of the handheld intraoral scanner is pressed, while the digital movable item is on that particular location in the graphical user interface. In the present example, the occurrence would be enabling a cutting tool for cutting or trimming the digital 3D model.

Changing the appearance of at least a part of the digital movable item to reflect an instruction of the digital element would improve a guidance or an assisting of the user in selecting the correct digital element of the one or more digital elements. A user of the intraoral scanner who would otherwise not be able to view a selectable digital element in the graphical user interface would be able to view a digital element due to the changing of shape and transparency of the digital movable item. For example, the digital movable item may become smaller in size or transparent when approaching a digital element. In another example, the appearance of the digital movable item may mimic the digital element that the digital movable item is closest to or overlapping in the graphical user interface, and thereby, the digital element becomes indirectly visible. A user of the system may be standing at a distance from the graphical user interface that may not allow the user to have a clear view of the details of the graphical user interface, and thus not able to distinguish the digital elements in the graphical user interface. In such a situation, the system is further beneficial as the digital movable item may increase in size when positioned over a digital element and at the same time may change appearance to reflect the instruction of the digital element. The system allows an increased accessibility, guiding, or assisting of the user of the intraoral scanner system.

Thus, an intraoral scanner system is provided, that may be configured to change an appearance of a digital movable item that corresponds to an instruction that relates to a digital 3D model of a dental object. The system may comprise a handheld intraoral scanner that may be configured to obtain light information reflected from a dental object. The handheld intraoral scanner may include a motion sensor. The intraoral scanner system may comprise one or more processors that may be configured to process the light information into a digital 3D model of the dental object. The one or more processors may be configured to receive a motion signal from the motion sensor.

The intraoral scanner system may comprise a graphical user interface that may be configured to display the digital 3D model, a digital movable item, and one or more digital elements. Each of the one or more digital elements may include an instruction to modify an orientation or a design of the digital 3D model. The one or more processors may be configured to control a movement of the digital movable item based on the motion signal. At least a part of the digital movable item may be configured to change an appearance when being at a position over or moved towards a digital element of the one or more digital elements. The appearance may reflect the instruction of the digital element of the one or more digital elements.

A further aspect of the present disclosure is to provide a method for controlling an appearance of at least a part of a digital movable item (e.g. cursor) on a graphical user interface that is configured to display a digital 3D model of a dental object, when moving the digital movable item over a digital element. The appearance may be controlled to reflect an instruction to be applied when the digital element is selected using a handheld intraoral scanner.

According to the aspect, a method for controlling an appearance of at least a part of a digital movable item on a graphical user interface that may be configured to display a digital 3D model of a dental object is provided.

The dental object may be a tooth, a part of a tooth, an upper jaw or a lower jaw or parts thereof, an entire dentition, a gingiva, or part of the gingiva.

Controlling the appearance of at least a part of the digital movable item may be performed by one or more processors. The one or more processors may be located at least partly in a handheld intraoral scanner, a computer device such as a desktop computer, a laptop, a tablet, or may be at least partly located in a server as a cloud-based computing. The one or more processors may be configured to generate a digital 3D model of the dental object. The one or more processors may be configured to generate the digital 3D model of the dental object using light information, such as intraoral scan data, that may be reflected from the dental object and acquired by the handheld intraoral scanner.

The one or more processors may be configured to display the generated digital 3D model of the dental object on a graphical user interface. The graphical user interface may be displayed on a display unit, such as a computer screen, a tablet, etc., and may be operably connected to the one or more processors.

The graphical user interface may be configured to display one or more digital elements, such as icons that includes instructions that relates to an action to be performed on the digital 3D model of the dental object. The icons may be selectable digital tools. The graphical user interface may be configured to display a digital movable item, such as a cursor.

The method may comprise receiving a motion signal from a motion sensor of a handheld intraoral scanner.

The handheld intraoral scanner may comprise a motion sensor. The motion sensor may comprise a gyroscope that may be configured to provide information about a rotation of the handheld intraoral scanner. The motion sensor may comprise an accelerometer that may be configured to provide information of a movement of the handheld intraoral scanner. The motion sensor may be configured to provide motion signals that may provide information that relate to a rotation and/or a movement of the handheld intraoral scanner.

The method may comprise controlling a movement of the digital movable item on the graphical user interface.

The movement of the digital movable item may be controlled according to the received motion signal.

The one or more processors may receive the motion signals and move the digital movable item (e.g. cursor) in the graphical user interface according to the received motion signals.

The method may comprise changing the appearance of the at least part of the digital movable item when moving the digital movable item at least partly to a position over a digital element of one or more digital elements. The appearance of the at least part of the digital movable item may occur when at least a part of the digital movable item is positioned over or moved towards the digital element. The change of appearance may be performed by the one or more processors. The change of appearance may comprise changing a shape, a content, a size, a colour, or a transparency of the digital movable item.

The digital element may comprise an instruction to modify an orientation or design of the digital 3D model and may be displayed on the graphical user interface. The digital element may be one of the one or more digital elements. The digital element may comprise an instruction to perform a modification of the digital 3D model, such as trimming, cutting, adding, rotating, moving, copying, zooming, capturing an instant image, etc. The instruction may be stored in a data store such as a memory unit of a computer or in a server. The instruction may apply when a user interface of the handheld intraoral scanner receives a user interaction, such as a pressing of digital or physical button of the user interface, while the digital movable item is positioned over or moved towards the digital element comprising the instruction.

The appearance may reflect the instruction of the digital element of the one or more digital elements. The appearance may change according to the instruction of the digital element, when the digital movable item is positioned over or moved towards the digital element. The one or more processors may obtain information about the instruction, and change the appearance of the digital movable item, to reflect the instruction. The one or more processors may change the appearance of the digital movable item into changing a shape (e.g. copying the shape of the digital element or an image of the digital element), a content (e.g. changing an image or icon that reflects the instruction of the digital element), a colour, transparency, size, or add dynamics (e.g. mimicking a function of the instruction) or information (e.g. text, numbers, symbols).

For example, the digital element of the one or more digital elements is a drawing tool for e.g. drawing lines on the digital 3D model, or marking areas on the digital 3D model. When the digital movable item, is within a range of the digital element that allows the digital movable item to select the digital element, the shape of the digital movable item is changed into e.g. a paint brush or a crayon. If the digital movable item is positioned over a digital element that comprises an instruction to perform thinner line drawings in relation to a default line thickness drawing, the digital movable item may become smaller, indicating that the line drawing is thinner than the default thickness of the line drawing.

Changing the appearance of at least a part of the digital movable item when positioned over or moved towards a digital element to reflect the instruction of the digital element, may allow a user to improve a guidance or an assisting of the user by making visible what may be performed if a digital element is selected. A user of the intraoral scanner who would otherwise not be able to view a selectable digital element in the graphical user interface, may by the above described digital movable item, be able to view the digital element, since the digital movable item may become smaller in size or become transparent, or the user may be able to anticipate the digital element that is hidden from the users view, since the digital movable item may change content or shape, into reflecting the instruction of the digital element that is hidden behind the digital movable item. The method is further beneficial, since a user may be standing at a distance from the graphical user interface, that may not allow user to have a clear view of the details of the graphical user interface, and thus not able to distinguish the digital elements in the graphical user interface. Since the digital movable item may increase in size when positioned over a digital element, and at the same time may change appearance to reflect the instruction of the digital element, the method may allow for an increased accessibility, guiding, or assisting of the user.

Changing the appearance of at least a part of the digital movable item to reflect an instruction of the digital element would improve a guidance or an assisting of the user in selecting the correct digital element of the one or more digital elements. A user of the intraoral scanner who would otherwise not be able to view a selectable digital element in the graphical user interface would be able to view a digital element due to the changing of shape and transparency of the digital movable item. For example, the digital movable item may become smaller in size or transparent when approaching a digital element. In another example, the appearance of the digital movable item may mimic the digital element that the digital movable item is closest to or overlapping in the graphical user interface, and thereby, the digital element becomes indirectly visible. A user of the system may be standing at a distance from the graphical user interface that may not allow the user to have a clear view of the details of the graphical user interface, and thus not able to distinguish the digital elements in the graphical user interface. In such a situation, the system is further beneficial as the digital movable item may increase in size when positioned over a digital element and at the same time may change appearance to reflect the instruction of the digital element. The system allows an increased accessibility, guiding, or assisting of the user of the intraoral scanner system.

Thus, a method for controlling an appearance of at least a part of a digital movable item on a graphical user interface that may be configured to display a digital 3D model of a dental object is provided. The method may comprise receiving a motion signal from a motion sensor of a handheld intraoral scanner. The method may comprise controlling a movement of the digital movable item on the graphical user interface that may be according to the received motion signal.

The method may comprise changing the appearance of the at least part of the digital movable item when moving the digital movable item at least partly to a position over a digital element of one or more digital elements that may comprise an instruction to modify an orientation or design of the digital 3D model and that may be displayed on the graphical user interface. The appearance may reflect the instruction of the digital element of the one or more digital elements.

The change of the appearance may comprise a change in transparency of the at least part of the digital movable item.

For example, the digital movable item, which in the present example may be a cursor, may become partly transparent when positioned over a digital element, which may for example be an instant image capturing tool, which may be displayed as a camera. The digital movable item (i.e. the cursor) may be partly transparent, such as visually faded, and the digital element (i.e. the camera) may become visible behind the digital movable item. The level of the transparency of the digital movable item may be determined based on coordinates provided by the motion sensor of the handheld intraoral scanner. For example, the one or more processors may be configured to determine the digital element the user of the system wants to select with the digital movable item. For example, the speed and the direction of the digital movable item that are provided by the motion sensor of the handheld intraoral scanner are used by the one or more processors to determine which digital element the user wants to select with the digital movable item. The one or more processors is further configured to change the level of the transparency of the digital movable item when approaching to the digital element which the one or more processors has identified as the one the user wants to select. The transparency increases as the distance between the digital movable item and the digital element reduce

Changing the appearance of the digital movable item to become at least partly transparent, may allow for an improved guidance and assistance in viewing the digital elements in the graphical user interface, since the feature may allow the digital element to become visible even when located behind the digital movable item in the graphical user interface.

The handheld intraoral scanner may comprise a user interface that may be configured to facilitate a user interaction with the graphical user interface. The instruction to modify the orientation or the design of the digital 3D model may be applied when an interaction is facilitated through the user interface.

A user interaction with the graphical user interface may be received from a user interface of the handheld intraoral scanner. The instruction to modify the orientation or the design of the digital 3D model may be applied when the user interaction is received from the user interface.

The user interface may be arranged on a surface of the handheld intraoral scanner, and may comprise digital buttons (e.g. a touch screen) and/or physical buttons. When the digital movable item is positioned over a digital element in the graphical user interface, the instruction of the digital element may be applied, when the user interface receives a user interaction, such as pressing a button. The user interaction with the user interface may be received by the one or more processors, and the one or more processors may subsequently execute the instruction of the digital element, if the digital movable item is positioned over the digital element in the graphical user interface.

For example, the digital movable item may be positioned partly over a digital element comprising an instruction for rotating the digital 3D model. The one or more processors may register a user interaction with the user interface of the handheld intraoral scanner (e.g. pressing a physical button of the user interface of the handheld intraoral scanner), the one or more processors may subsequently execute the instruction of rotating the digital 3D model. Interacting with the graphical user interface using a user interface of the handheld intraoral scanner may allow a user to perform digital operations on the digital 3D model in the graphical user interface, without having to use other devices, such as a computer mouse or touching a screen displaying the graphical user interface, thereby improving the hygiene during a scan session.

The interaction applying the instruction in the graphical user interface may comprise any of the following: selecting one of the one or more digital elements, rotating the digital 3D model, selecting an option, selecting a digital tool, and/or browsing through different views of the graphical user interface.

A user may for example browse through the menus of the graphical user interface, rotate the digital 3D model, or select a digital element with an instruction for adding drawings to the digital 3D model, and subsequently selecting a digital element with instructions for choosing a colour for the added drawings, by moving the digital movable item over a desired digital element as the digital elements mentioned above, and by pressing a physical button of the user interface of the handheld intraoral scanner, applying the desired instructions (i.e. selecting the desired digital elements).

The handheld intraoral scanner may include a wireless communication interface that may be configured to wirelessly control the digital movable item on the graphical user interface. The digital movable item may be wirelessly controlled on the graphical user interface using the handheld intraoral scanner.

The wireless communication interface may be a Wi-Fi interface, a Bluetooth component, or other wireless communication components known in the art. The one or more processors may be configured to receive control input from the handheld intraoral scanner, such as motion signals, and may be configured to control the movement of the digital movable item in the graphical user interface according to the received control input, by sending and receiving information through the wireless communication interface, which the display unit displaying the graphical user interface, the handheld intraoral scanner, and the one or more processors are operably connected to.

When the at least part of the digital movable item is at a position over or moved towards one of the one or more digital elements, the at least part of the digital movable item may be configured to change the appearance to one or more of the following: imitate, mimic, copy, resemble, or represent the digital element; display symbols, text, and/or numbers; change to a smaller size; change colour; and/or fade or become at least partly transparent.

Changing the appearance of the at least part of the digital movable item when moving the digital movable item at least partly to a position over a the digital element, may comprise one or more of: imitating, mimicking, copying, resembling, or representing the digital element; displaying symbols, text, and/or numbers; changing to a smaller size; changing colour; and/or fading or becoming at least partly transparent.

The change of the appearance of the digital movable item according to the instruction of the digital element, over which the digital movable item is positioned, may be performed using the one or more processors.

The at least part of the digital movable item may be configured to change appearance to a default appearance, when the digital movable item is not positioned over the one or more digital elements or when the instruction of the digital element is applied.

The appearance of the at least part of the digital movable item may be changed to a default appearance, when the digital movable item is not positioned over the digital element, or when the instruction of the digital element is applied.

For example, the digital movable item may appear in a default shape, such as a cursor shaped as an arrow. When the digital movable item is subsequently moved to a position over a digital element with an instruction of enlarging a view of a part of the digital 3D model (e.g. a zoom-in function), the digital movable item may change a shape into a magnifying glass. Subsequently, the a user may press a physical button on the handheld intraoral scanner to apply the instruction. After the instruction has been applied, the cursor may change appearance to the default shape, which in the present example may be an arrow. Alternatively, when the appearance of the digital movable item has changed to a magnifying glass, the digital movable item may be moved to another position away from the digital element without having applied the instruction of the digital element by pressing the physical button, the digital movable item may change appearance into the default shape (i.e. the arrow).

The one or more processors may be configured to change the appearance of the at least part of the digital movable item, when a digital 3D model modification tool displayed in the graphical user interface is selected and the digital movable item is moved within a predefined distance of an edge of the digital 3D model.

The appearance of the at least part of the digital movable item may change, when a digital 3D model modification tool is selected and the digital movable item is moved within a predefined distance to an edge of the digital 3D model.

The digital 3D model modification tool may be a cutting or trimming tool, may be an adding tool for adding digital material, drawings, objects, or text to the digital 3D model, or may be any digital 3D model modification tool known in the art.

For example, in the graphical user interface, if a digital element that may comprise an instruction to cut parts of the digital 3D model, such as a cutting tool, is selected using the digital movable item, the digital movable item may change appearance into for example a scissor icon, when the digital movable item is moved within a distance of for example 5 times a length of the digital movable item from any edge of the digital 3D model.

Changing the appearance of the digital movable item when moved to a predefined distance to an edge of the digital 3D model, may allow an instruction to be applied or a modification operation to be performed already at an edge of the digital 3D model, which may allow a user to view where the e.g. a trim may be performed on an edge of the digital 3D model, instead of changing the appearance when the digital movable item has reached the edge of the digital 3D model.

The at least part of the digital movable item may be configured to change the appearance to appear fading, become at least partly transparent, or change into a smaller size, when a digital cutting or trimming tool is selected, and the digital movable item is moved within a predefined proximity of an edge of the digital 3D model.

The at least part of the digital movable item may change to appear fading, become at least partly transparent, or become reduced in size, when a digital 3D model modification tool is selected and the digital movable item is moved within a predefined distance to an edge of the digital 3D model.

Changing the appearance of the digital movable item to become at least partly transparent, fade, or change into a smaller size, may allow a user to view regions of an edge of the digital 3D model, that otherwise would be hidden from the view of the user, thus allowing for an improvement of an assisting of a user in performing modifying operation at an edge of the digital 3D model.

For example, if a digital element is selected that comprises an instruction for performing a cut (i.e. a digital cutting tool), and the digital movable item is moved towards an edge of the digital 3D model that is at a proximity of for example 3 times a length of the digital movable item, the digital movable item may become transparent, thereby allowing a user to view a region at an edge of the digital 3D model that may be behind the digital movable item, that otherwise would be hidden by the digital movable item. In another example, the digital movable item may become reduced in size, thereby allowing a user to view a region of the edge of the digital 3D model behind the digital movable item, that otherwise would be hidden by the digital movable item, from being viewed by a user.

At least a part of the digital element of the one or more digital elements may be revealed in the graphical user interface, or a graphical representation of at least a part of the digital element of the one or more digital elements may be displayed in the graphical user interface, when the digital movable item is positioned over or moved towards the digital element.

The one or more processors may be configured to reveal the digital element in the graphical user interface, when the digital movable item is positioned over the digital element. The digital element may be revealed over the digital movable item or may be revealed in a larger size at another position in the graphical user interface. Revealing the digital element when the digital movable item is position over the digital element, may allow a user to view the digital element that may be selected using the user interface of the handheld intraoral scanner, when the digital movable item is positioned over the digital element, thereby hiding the digital element. This feature may be beneficial when a user is viewing the graphical user interface at a distance, that prevents a user from viewing details of the digital element in the graphical user interface, since the feature unhides the otherwise hidden digital element (hidden behind the digital movable item), or increases a size of the digital element in the graphical user interface.

For example, a user may move the digital movable item, using the handheld intraoral scanner, over a digital element on the graphical user interface, that may comprise an instruction of rotating the digital 3D model, and that may have a shape as an curved arrow. The user is standing in a clinic and relatively far from the display unit that is displaying the digital 3D model in the graphical user interface, and is therefore unable to identify, whether the digital element that the digital movable item is covering, is a curved arrow or a straight arrow. The feature mentioned above may reveal the curved arrow and enlarge the shape of it, such that the user may identify the digital element as having a shape or a curved arrow.

The instruction may comprise changing at least a part of the appearance of the digital movable item to represent the digital element of the one or more digital elements, become smaller, or at least partly transparent, when the digital movable item is positioned over the digital element. The instruction may comprise changing at least a part of the appearance of the digital movable item to a graphically dynamic appearance, when the digital movable item is positioned over the digital element of the one or more digital elements.

The digital movable item may change a part of the appearance, such that only a part of the digital movable item may be changed. For example, the digital movable item, when positioned over a digital element with an instruction of capturing an instant image of the digital 3D model, may comprise a shape wherein a part of the digital movable item has a default shape of the digital movable item (e.g. an arrow), while another part of the digital movable item has a shape that mimics a camera icon. This feature may assist in selecting a digital element, even if only a part of the digital movable item is over digital element. The digital movable item may further change appearance into having a dynamic appearance, such as a dynamic pattern. For example, the digital movable item, when positioned over a digital element with an instruction of performing a trimming operation to the digital 3D model (a trimming tool), may change an appearance into moving in a pattern, that mimics the movement of a cutting scissor.

Those skilled in the art will recognize still other aspects of the present application upon reading and understanding the attached description.

### BRIEF DESCRIPTION OF THE DRAWINGS

Aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically illustrates an intraoral scanner system comprising a handheld intraoral scanner, a processer, and a graphical user interface;

FIG. 2 schematically illustrates an example of the digital movable item changing appearance when moved over a digital element in the graphical user interface.

FIG. 3 schematically illustrates another example of the digital movable item changing appearance when moved over another digital element in the graphical user interface.

FIG. 4 schematically illustrates another example of a change of the appearance of the digital movable item;

FIGS. 5A-5B schematically illustrate different appearances of the digital movable item; and

FIG. 6 illustrates a table with an overview of a method for changing an appearance of the digital movable item when positioned over a digital element in the graphical user interface.

### DETAILED DESCRIPTION OF THE DRAWINGS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the devices, systems, mediums, programs and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

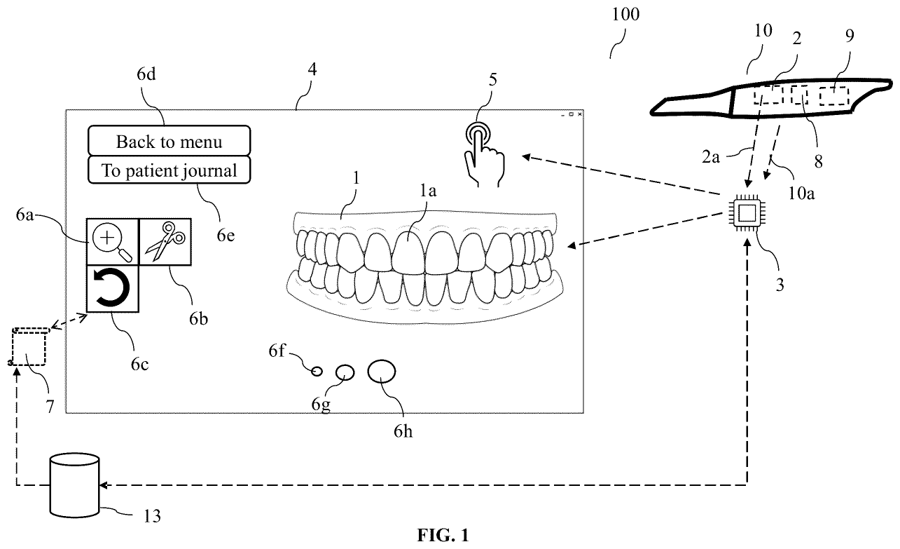

FIG. 1 schematically illustrates an intraoral scanner system 100. The intraoral scanner system 100 is shown comprising a handheld intraoral scanner 10, comprising a user interface 8 (e.g. one or more physical buttons and/or one or more digital buttons, such as a touch screen), a wireless communication interface 9 (e.g. Wi-Fi interface), and a motion sensor 2. The motion sensor 2 may comprise a gyroscope 11 (not shown) and/or an accelerometer 12 (not shown). The figure schematically indicates (by a dashed arrow) light information 10a that has been obtained by the handheld intraoral scanner 10 being received by one or more processors 3. The one or more processors 3 is in FIG. 1 schematically illustrated as one unit. The one or more processors 3 may be arranged at least partly in the handheld intraoral scanner 10, a computer device (e.g. a laptop), a display device (e.g. a tablet), or a server (e.g. cloud based processing). The figure further schematically indicates (by a dashed arrow) a motion signal 2a transmitted from the motion sensor 2 to the one or more processors 3. The motion signal may be a signal with information about a rotation (from the gyroscope 11) and/or a movement (from the accelerometer 12) of the handheld intraoral scanner 10.

FIG. 1 further illustrates a graphical user interface 4. The graphical user interface 4 may be displayed on a display device (not shown) such as a computer screen, a laptop screen, a tablet, etc. The graphical user interface 4 is illustrated showing a digital 3D model 1 of a dental object la that is shown as a dentition. The digital 3D model 1 may be generated by the one or more processors 3 using the light information 10a obtained by the handheld intraoral scanner 10.

The graphical user interface 4 is shown displaying several digital elements 6a-6h. The digital elements 6a-6h may each comprise an instruction 7. For clarity, only an instruction 7 for digital element 6c is illustrated. The instruction 7 may be stored in a datastore 13, such as a memory unit of the intraoral scanner system 100 or in a server. The datastore 13 is in FIG. 1 shown as being located external relative to the handheld intraoral scanner 10, such as a remote server. The one or more processors 3 is shown, by a dashed two-way arrow, operatively connected to the data store 13, such as through the internet. The one or more processors may thus be configured to save and retrieve data from the data store 13. The instruction 7 is schematically illustrated being stored in the data store 13. Each instruction 7 of each digital element 6 may be stored in the data store 13. The instruction 7 may include an instruction for performing an operation in the graphical user interface 4, such as illustrated by the digital element 6d and 6e, wherein by selecting the digital elements 6d or 6e, the graphical user interface 4 may display a menu of the graphical user interface 4 or display a patient journal, respectively. The instruction 7 may comprise information to change an appearance of the digital movable item 5, when the digital movable item 5 is moved over or towards the digital element 6 comprising the instruction 7. The instruction 7 may comprise information to modify an orientation and/or a design of the digital 3D model 1, and information to change an appearance of the digital movable item 5, when the digital movable item 5 is moved over or towards the digital element 6 comprising the instruction 7. The instruction 7 may include an instruction for performing an operation in the digital 3D model 1, such as illustrated by the digital element 6a, which may comprise an instruction for zooming in (i.e. enlarging the digital 3D model 1 or a part thereof). As an example and not a limitation, the graphical user interface 4 further illustrates other digital elements 6b, 6c, 6f, 6g, and 6h. The digital element 6b may comprise an instruction 7 for removing (i.e. cutting or trimming) parts of the digital 3D model 1. The digital element 6c may comprise an instruction 7 for rotating the digital 3D model 1. The digital element 6f may comprise an instruction 7 for reducing a size of a digital movable item 5 (i.e. a cursor), the digital element 6g may comprise an instruction 7 for changing the size of the digital movable item 5 to a default (predefined) or standard size, and the digital element 6h may comprise an instruction 7 for increasing the size of the digital movable item 5. The digital elements 6a-6h may each be selectable by the digital movable item 5, and individually perform the instruction 7 they comprise, when selected.

The figure further shows the digital movable item 5. The digital movable item 5 is shown as a cursor. The digital movable item 5 is configured to be moved within the graphical user interface 4, and configured to select the digital elements 6a-6h, when moved at least partly over a digital element 6 of the digital elements 6a-6h. FIG. 1 schematically illustrates that the movement of the digital movable item 5 is controlled by the handheld intraoral scanner 10 through the one or more processors 3, by the motion signal 2a. The motion sensor 2 sends a motion signal 2a to the one or more processors 3 comprising information about a rotation and/or a movement of the handheld intraoral scanner 10 (registered by the gyroscope 11 and/or the accelerometer 12 in the handheld intraoral scanner 10), and the one or more processors 3 controls the movement of the digital movable item 5 in the graphical user interface 4, according to the motion signal 2a. The figure thus schematically illustrates the movement of the digital movable item 5 being controlled by a movement of the handheld intraoral scanner 10. The wireless communication interface 9 may be configured to send the motion signal 2a to the one or more processors 3, if the one or more processors 3 is at least partly located outside the handheld intraoral scanner 10. The wireless communication interface 9 may further be configured to send a user interaction signal to the one or more processors 3, comprising information about a user interaction with the user interface 8 of the handheld intraoral scanner 10. The user interaction may be a registered interaction with the physical and/or digital buttons of the user interface 8, such as a pressing of a digital and/or physical button on the user interface 8. The one or more processors 3 may subsequent to receive the user interaction signal, control the digital movable item 5 to select a digital element 6, when the digital movable item 5 is over the digital element 6, while the user interaction signal is received by the one or more processors 3.

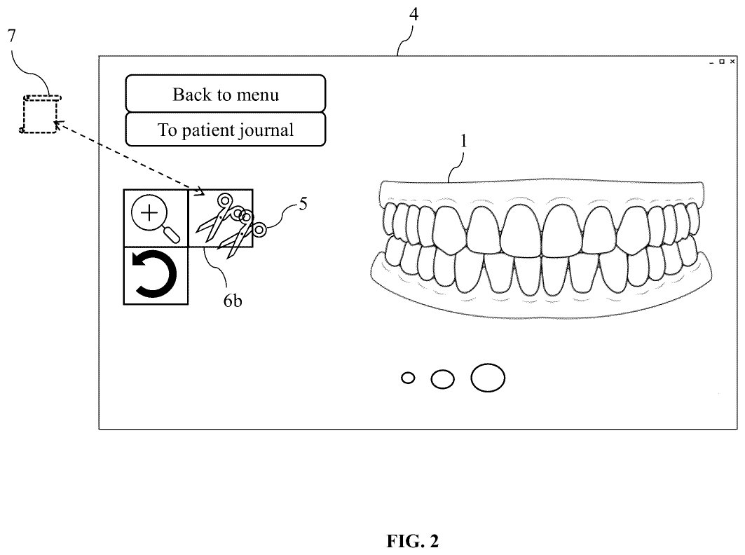

FIG. 2 schematically illustrates an example of the digital movable item 5 changing appearance according to an instruction 7 of a digital element 6. The figure illustrates that the digital movable item 5 has been moved partly over the digital element 6b, which in FIG. 2 is shown as a digital element 6b comprising an instruction 7 for performing a material removal from the digital 3D model 1, thus illustrated as a digital cutting or trimming tool. The one or more processors 3 is configured to change an appearance of the digital movable item 5 according to an instruction 7 of a digital element 6. The digital movable item 5 is thus shown in a changed appearance according to the instruction 7 which in the present example is a material removal operation, thus the digital movable item 5 changing appearance into displaying a similar icon as an icon of the digital element 6b, which in the present is a scissor, indicating a material removal operation (i.e. a cutting or trimming function).

Thus, the one or more processors 3 may have received a motion signal 2a from the motion sensor 2 in the handheld intraoral scanner 10 comprising information to move the digital movable item 5 towards the digital element 6b in the graphical user interface 4. The one or more processors 3 upon receiving the motion signal 2a, moves the digital movable item 5 towards the digital element 6b. The one or more processors 3 may register an instruction 7 of the digital element 6b in a datastore, and changes the appearance of the digital movable item 5 into mimicking the digital element 6b. I one example, the appearance may mimic an icon of the digital element 6 (such as in the present example). In another example, the one or more processors 3 may change the appearance of the digital movable item 5 to become smaller, to become larger, to become transparent or at least partly transparent, or to become dynamic and mimic a movement. The digital movable item 5 is shown as a scissor, indicating that if a user interaction is received from the user interface 8 of the handheld intraoral scanner 10, such as a pressing of a digital or physical button of the user interface 8, while the digital movable item 5 is positioned over the digital element 6b and the appearance of the digital movable item 5 is displayed as the scissor, the one or more processors 3 will select the digital element 6b, thereby selecting a function of performing an operation of material removal on the digital 3D model 1, thereby enabling a cutting or trimming function of the intraoral scanner system 100.

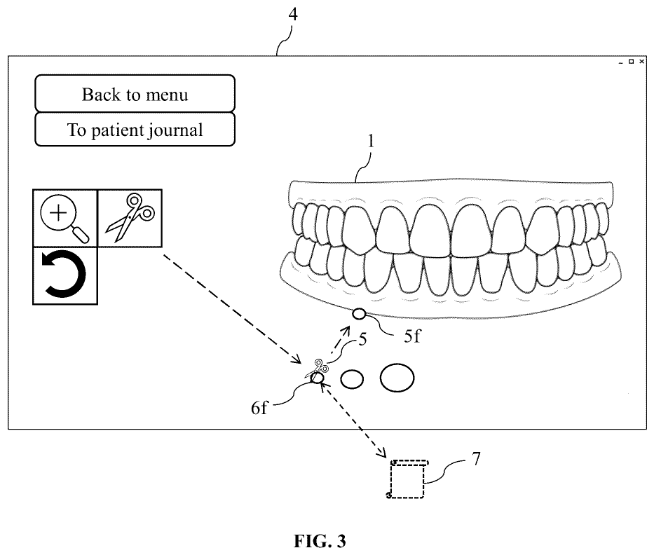

FIG. 3 schematically illustrates another example of the digital movable item 5 changing appearance. The digital movable item 5 is shown positioned at least partly over a digital element 6f in the graphical user interface 4. The digital element 6f is in the present example displayed as a circle that is smaller than two other neighbouring circles, to visually indicate that the digital element 6f comprises an instruction 7, that reduces the size of the digital movable item 5. The digital element 6f is thus shown comprising an instruction 7 for reducing the size of the digital movable item 5. FIG. 3 shows the digital movable item 5 having a shape as a scissor, and smaller in size relative to the size of the digital movable item 5 in the previous example illustrated in FIG. 2. As illustrated in FIG. 3, when the digital movable item 5 is located over the digital element 6f, and having an appearance that displays the digital movable item 5 being reduced in size, if the one or more processors 3 registers a user interaction with the user interface 8 of the handheld intraoral scanner 10, the one or more processors 3 may select the digital element 6f, thereby selecting an operation in the graphical user interface, where a material removal operation is enabled, that allows a material removal from the digital 3D model of smaller size, than a material removal size when the digital element 6g or 6h is selected. In one example, when the one or more processors 3 performs the selection of the digital element 6f, the digital movable item 5 may subsequently change appearance to a shape that may allow for an increased precision of material removal operation (i.e. cutting or trimming), such as the circular shape of the digital element 6f, and as illustrated by the digital movable item 5 (in FIG. 3 denoted as 5f for clarity purposes) having changed shape into a circle of a similar size as the digital element 6f in FIG. 3. The digital movable item 5 shaped as the digital element 6f is shown at an edge of the digital 3D model 1, wherein a cutting or trimming operation may be performed on the digital 3D model 1 at the shown position.

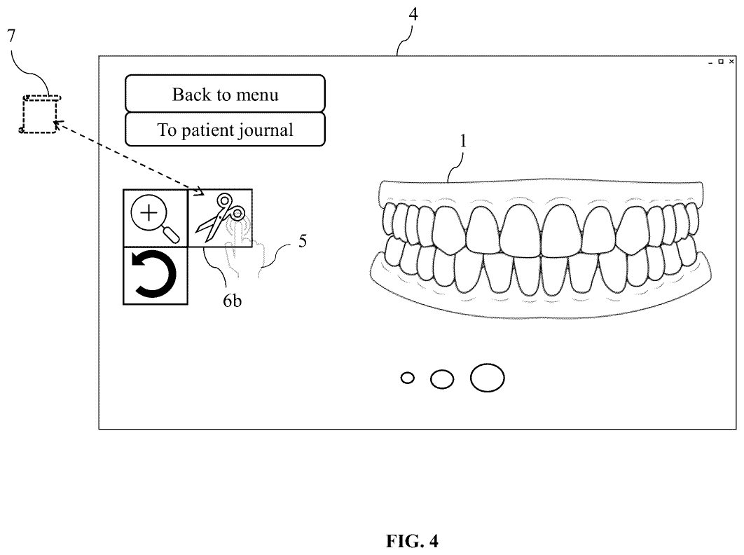

FIG. 4 schematically illustrates an example, wherein the digital movable item 5 is shown partly transparent. The digital element 6b is illustrated comprising an instruction 7, which when executed by the one or more processors 3, changes the appearance of the digital movable item 5 to become at least partly transparent when positioned over the digital element 6b, such that the digital element 6b is visible, even when the digital movable item 5 is positioned over the digital element 6b.

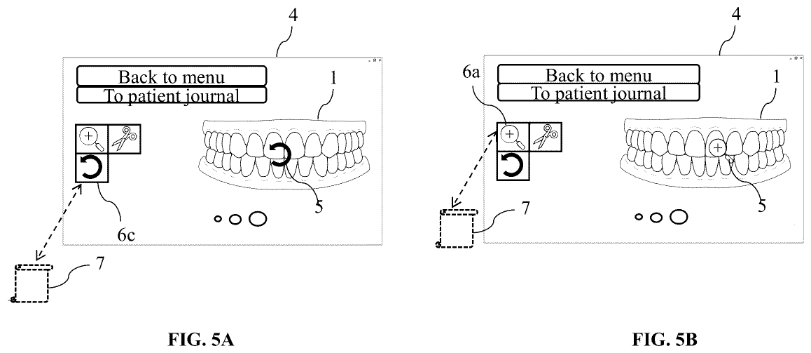

FIGS. 5A and 5B schematically illustrate different examples of the changing of an appearance of the digital movable item 5. In FIG. 5A, the appearance of the digital movable item 5 has been changed from an initial appearance, which may be a default appearance as shown in FIG. 1, to a an appearance mimicking an icon of the digital element 6c, that comprises an instruction 7 for changing the appearance of the digital movable item 5 into a curved arrow, thereby indicating a rotation function. When the digital element 6c is selected, the digital 3D model 1 may be rotated in the graphical user interface 4.

FIG. 5B schematically illustrated a different example, where the digital movable item 5 has changed shape into a magnifying glass, indicating a zoom-in function, thus mimicking the digital element 6a, that comprises an instruction 7 to change the appearance of the digital movable item 5 into a magnifying glass, and that when selected, enables an operation that enlarges a view of a part of the digital 3D model 1 (zoom-in function) in the graphical user interface 4.

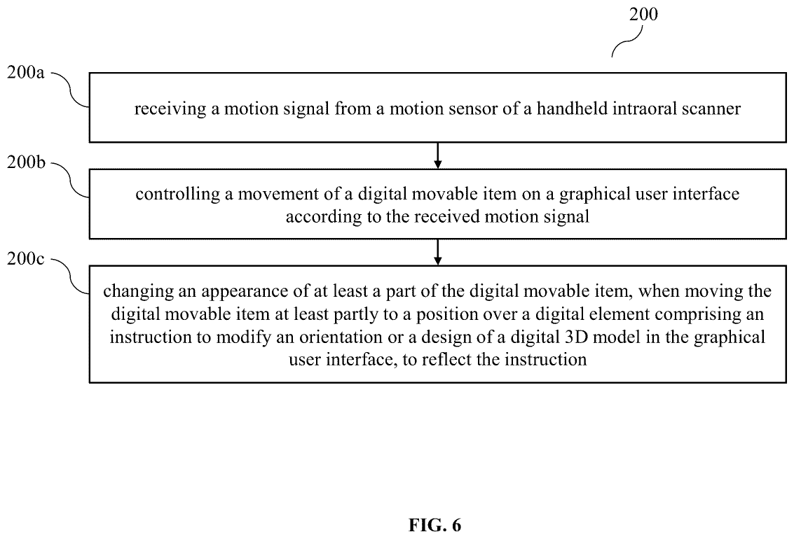

FIG. 6 schematically illustrates a table 200 with an overview of the method for changing an appearance of the digital movable item when positioned over a digital element in the graphical user interface.

The figure shows a first step 200a, wherein a motion signal 2a from a motion sensor 2 of a handheld intraoral scanner 10 is received. The motion signal 2a may be sent from a gyroscope 11 and/or an accelerometer 12 of the motion sensor 2 in the handheld intraoral scanner 10, and may be received by one or more processors 3 that is operably connected to the handheld intraoral scanner 10. The motion signal 2a may comprise information about a physical rotation and/or a physical movement of the handheld intraoral scanner 10, registered by the gyroscope 11 and/or the accelerometer 12 of the motion sensor 2, respectively. The figure shows a second step 200b, wherein a movement of a digital movable item 5 on a graphical user interface 4 is controlled, according to the received motion signal 2a. The digital movable item 5 may be a cursor. The graphical user interface 4 may be displayed on a display unit that is operably connected to the one or more processors 3. The digital movable item 5 may be moved by the one or more processors 3 according to the received motion signal 2a. The one or more processors 3 may perform a movement of the digital movable item 5 on the graphical user interface 4 that corresponds to a physical movement of the handheld intraoral scanner 10. The one or more processors 3 may be configured to process the received motion signal 2a, thereby obtaining information about the registered physical movement of the handheld intraoral scanner 10. The one or more processors 3 may be configured to analyze the received motion signal 2a and thereby obtain information about the physical movement of the handheld intraoral scanner 10. The one or more processors 3 may be configured to move the virtual movable item 5 in the graphical user interface 4 according to the registered physical movement of the handheld intraoral scanner 10.

The one or more processors 3 may be at least partly located in the handheld intraoral scanner 10, in the display unit displaying the graphical user interface 4, such as a tablet, in a computer devices, such as a desktop computer or a laptop pc operably connected to the display unit displaying the graphical user interface 4, or may be located in a remote computer, such as a server, and performing a cloud-based-computing. The handheld intraoral scanner 10, the display unit displaying the graphical user interface 4, and the one or more processors may all be operably connected to each other via a wireless connection, such as a Wi-Fi connection. The figure shows a third step 200c, wherein an appearance of at least a part of the digital movable item 5 is changed, when positioned over a digital element 6 that comprises an instruction 7 to modify an orientation or a design of a digital 3D model 1 displayed in the graphical user interface 4, to reflect the instruction 7. Thus, when the one or more processors 3 move the digital movable item 5 to a position at least partly over the digital element 6, the one or more processors 3 change an appearance of the digital movable item 5. The appearance of the digital movable item 5 may change to an appearance, that reflects the instruction 7 that is comprised in the digital element 6. The method may thus assist or guide a user in assessing an action to be performed, when the digital element 6 is selected using a user interface 9 of the handheld intraoral scanner 10 to select the digital element 6 while the digital movable item 5 is position over the digital element 6.

Although some embodiments have been described and shown in detail, the disclosure is not restricted to such details, but may also be embodied in other ways within the scope of the subject matter defined in the following claims. In particular, it is to be understood that other embodiments may be utilized, and structural and functional modifications may be made without departing from the scope of the present invention.

Benefits, other advantages, and solutions to problems have been described herein with regard to specific embodiments. However, the benefits, advantages, solutions to problems, and any component(s)/unit(s) that may cause any benefit, advantage, or solution to occur or become more pronounced are not to be construed as critical, required, or essential features or components/elements of any or all the claims or the invention. The scope of the invention is accordingly to be limited by nothing other than the appended claims, in which reference to a component/unit/element in the singular is not intended to mean “one and only one” unless explicitly so stated, but rather “one or more.” A claim may refer to any of the preceding claims, and “any” is understood to mean “any one or more” of the preceding claims.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e., to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The step of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein but is to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### Items

1. An intraoral scanner system configured to display a digital 3D model of a dental object, and wherein the system comprising:
   a handheld intraoral scanner that is configured to obtain light information reflected from a dental object, and wherein the handheld intraoral scanner includes a motion sensor;
   one or more processors that is configured to process the light information into a digital 3D model of the dental object, and to receive a motion signal from the motion sensor; and
   a graphical user interface that is configured to display the digital 3D model, a digital movable item, and one or more digital elements, and wherein each of the one or more digital elements include an instruction to modify an orientation or a design of the digital 3D model, and
      wherein the one or more processors is configured to control a movement of the digital movable item based on the motion signal, and wherein at least a part of the digital movable item is configured to change an appearance when being at a position over or moved towards a digital element of the one or more digital elements, and wherein the appearance reflects the instruction of the digital element of the one or more digital elements.
2. The system according to item 1, wherein the change of the appearance comprises a change in transparency of the at least part of the digital movable item.
3. The system according to any of the previous items, wherein the handheld intraoral scanner comprises a user interface that is configured to facilitate a user interaction with the graphical user interface, wherein the instruction to modify the orientation or the design of the digital 3D model is applied when an interaction is facilitated through the user interface.
4. The system according to item 3, wherein the user interface comprises a physical or a digital button.
5. The system according to any of items 3-4, wherein the instruction in the graphical user interface comprises one or more of the following: selection of one of the one or more digital elements, rotation of the digital 3D model, selection of an option, selection of a digital tool, and/or browsing through different views of the graphical user interface.
6. The system according to any of the previous items, wherein the handheld intraoral scanner includes a wireless communication interface that is configured to wirelessly control the digital movable item on the graphical user interface.
7. The system according to any of the previous items, wherein the more motion sensor comprises at least one or more of a gyroscope and/or an accelerometer.
8. The system according to any of the previous items, wherein when being at a position over or moved towards one of the one or more digital elements, the at least part of the digital movable item is configured to change the appearance to one or more of the following:
   imitate, mimic, copy, resemble, or represent the digital element;
   display symbols, text, and/or numbers;
   change to a smaller size;
   change colour; and/or
   fade or become at least partly transparent.
9. The system according to any of the previous items, wherein the at least part of the digital movable item is configured to change appearance to a default appearance, when the digital movable item is not positioned over the one or more digital elements or when the instruction of the digital element is applied.
10. The system according to any of the previous items, wherein the digital movable item comprises a cursor, and wherein the one or more digital element comprise one or more of an icon or one or more of a digital button.
11. The system according to any of the previous items, wherein the one or more processors is at least partially located in the handheld intraoral scanner, in a computer device operatively connected to the handheld intraoral scanner, a display unit that is configured to display the graphical user interface, and/or to a server.
12. The system according to any of the previous items, wherein the one or more processors is configured to change the appearance of the at least part of the digital movable item, when a digital 3D model modification tool displayed in the graphical user interface is selected and the digital movable item is moved within a predefined distance of an edge of the digital 3D model.
13. The system according to item 12, wherein the at least part of the digital movable item is configured to change the appearance to appear fading, become at least partly transparent, or change into a smaller size, when:
   a digital cutting or trimming tool is selected, and
   the digital movable item is moved within a predefined proximity of an edge of the digital 3D model.
14. The system according to any of the previous items, wherein:
   at least a part of the digital element of the one or more digital elements is revealed in the graphical user interface, or
   a graphical representation of at least a part of the digital element of the one or more digital elements is displayed in the graphical user interface,
      when the digital movable item is positioned over or moved towards the digital element.
15. The system according to any of the previous items, wherein the instruction comprises:
   changing at least a part of the appearance of the digital movable item to represent the digital element of the one or more digital elements, become smaller, or at least partly transparent, when the digital movable item is positioned over the digital element; or
   changing at least a part of the appearance of the digital movable item to a graphically dynamic appearance, when the digital movable item is positioned over the digital element of the one or more digital elements.
16. A method for controlling an appearance of at least a part of a digital movable item on a graphical user interface that is configured to display a digital 3D model of a dental object, the method comprising:
   receiving a motion signal from a motion sensor of a handheld intraoral scanner;
   controlling a movement of the digital movable item on the graphical user interface according to the received motion signal; and
   changing the appearance of the at least part of the digital movable item when moving the digital movable item at least partly to a position over a digital element of one or more digital elements that comprise an instruction to modify an orientation or design of the digital 3D model and that is displayed on the graphical user interface, wherein the appearance reflects the instruction of the digital element of the one or more digital elements.
17. The method according to item 16, wherein changing the appearance of the at least part of the digital movable item comprises changing a transparency of the at least part of the digital movable item.
18. The method according to any of the previous items 16-17, the method comprising:
   receiving a user interaction with the graphical user interface from a user interface of the handheld intraoral scanner, and
   applying the instruction to modify the orientation or the design of the digital 3D model, when the user interaction is received from the user interface.
19. The method according to item 18, wherein the user interface comprises a physical or digital button.
20. The method according to any of items 18-19, wherein the interaction applying the instruction in the graphical user interface comprises any of the following: Selecting one of the one or more digital elements, rotating the digital 3D model, selecting an option, selecting a digital tool, and/or browsing through different views of the graphical user interface.
21. The method according to any of the previous items 16-20, wherein the method comprises wirelessly controlling the digital movable item on the graphical user interface using the handheld intraoral scanner.
22. The method according to any of the previous items 16-21, wherein the motion signal comprises signals from a gyroscope and/or an accelerometer.
23. The method according to any of the previous items 16-22, wherein changing the appearance of the at least part of the digital movable item when moving the digital movable item at least partly to a position over a the digital element, comprises one or more of:
   imitating, mimicking, copying, resembling, or representing the digital element;
   displaying symbols, text, and/or numbers;
   changing to a smaller size;
   changing colour; and/or
   fading or becoming at least partly transparent.
24. The method according to any of the previous items 16-23, wherein the method comprises changing the appearance of the at least part of the digital movable item to a default appearance, when the digital movable item is not positioned over the digital element or when the instruction of the digital element is applied.
25. The method according to any of the previous items 16-24, wherein the digital movable item comprises a cursor and wherein the digital element comprises one of an icon or one or more of a digital button.
26. The method according to any of the previous items 16-25, wherein the method comprises changing the appearance of the at least part of the digital movable item, when a digital 3D model modification tool is selected and the digital movable item is moved within a predefined distance to an edge of the digital 3D model.
27. The method according to item 26, wherein the at least part of the digital movable item is changed to appear fading, become at least partly transparent, or become reduced in size, when a digital 3D model modification tool is selected and the digital movable item is moved within a predefined distance to an edge of the digital 3D model.
28. The method according to any of the previous items 16-27, wherein the method comprises revealing at least a part of the digital element in the graphical user interface or displaying a graphical representation of at least a part of the digital element in the graphical user interface, when the digital movable item is positioned over or moved towards the digital element.
29. The method according to any of the previous items 16-28, wherein the instruction comprises:
   changing the appearance of the digital movable item to represent the digital element, to become smaller, or to become at least partly transparent, when the digital movable item is positioned over the digital element in the graphical user interface; or
   changing the appearance of at least a part of the digital movable item into a graphically dynamic appearance, when the digital movable item is positioned over the digital element.

1. An intraoral scanner system configured to change an appearance of a digital movable item that corresponds to an instruction that relates to a digital 3D model of a dental object, and wherein the system comprising:
a handheld intraoral scanner that is configured to obtain light information reflected from a dental object, and wherein the handheld intraoral scanner includes a motion sensor;
one or more processors that is configured to process the light information into a digital 3D model of the dental object, and to receive a motion signal from the motion sensor; and
a graphical user interface that is configured to display the digital 3D model, a digital movable item, and one or more digital elements, and wherein each of the one or more digital elements include an instruction to modify an orientation or a design of the digital 3D model, and
wherein the one or more processors is configured to control a movement of the digital movable item based on the motion signal, and
wherein at least a part of the digital movable item is configured to change an appearance when being at a position over or moved towards a digital element of the one or more digital elements, and wherein the appearance reflects the instruction of the digital element of the one or more digital elements.

2. The system according to claim 1, wherein the handheld intraoral scanner comprises a user interface that is configured to facilitate a user interaction with the graphical user interface, wherein the instruction to modify the orientation or the design of the digital 3D model is applied when an interaction is facilitated through the user interface.

3. The system according to claim 1, wherein when being at a position over or moved towards one of the one or more digital elements, the at least part of the digital movable item is configured to change the appearance to one or more of the following:
imitate, mimic, copy, resemble, or represent the digital element of the one more digital elements;
display symbols, text, and/or numbers;
change to a smaller size;
change colour; and/or
fade or become at least partly transparent.

4. The system to claim 1, wherein the digital movable item comprises a cursor, and wherein the one or more digital elements comprises one or more of an icon or one or more of a digital button.

5. The system according to claim 1, wherein the one or more processors is at least partially located in the handheld intraoral scanner, in a computer device operatively connected to the handheld intraoral scanner, a display unit that is configured to display the graphical user interface, and/or to a server.

6. The system according to claim 1, wherein the one or more processors is configured to change the appearance of the at least part of the digital movable item, when a digital 3D model modification tool displayed in the graphical user interface is selected and the digital movable item is moved within a predefined distance of an edge of the digital 3D model.

7. The system according to claim 6, wherein the at least part of the digital movable item is configured to change the appearance to appear fading, become at least partly transparent, or change into a smaller size, when:
a digital cutting or trimming tool is selected, and
the digital movable item is moved within a predefined proximity of an edge of the digital 3D model.

8. The system according to claim 1, wherein:
at least a part of the digital element of the one or more digital elements revealed in the graphical user interface, or
a graphical representation of at least a part of the digital element of the one or more digital elements is displayed in the graphical user interface, when the digital movable item is positioned over or moved towards the digital element of the one or more digital elements.

9. The system according to claim 1, wherein the instruction comprises:
changing at least a part of the appearance of the digital movable item to represent the digital element of the one or more digital elements, become smaller, or at least partly transparent, when the digital movable item is positioned over the digital element of the one or more digital elements; or
changing at least a part of the appearance of the digital movable item to a graphically dynamic appearance, when the digital movable item is positioned over the digital element of the one or more digital elements.

10. A method for controlling an appearance of at least a part of a digital movable item on a graphical user interface that is configured to display a digital 3D model of a dental object, the method comprising:
receiving a motion signal from a motion sensor of a handheld intraoral scanner;
controlling a movement of the digital movable item on the graphical user interface according to the received motion signal; and
changing the appearance of the at least part of the digital movable item when moving the digital movable item at least partly to a position over a digital element of one or more digital elements that comprise an instruction to modify an orientation or design of the digital 3D model and that is displayed on the graphical user interface, wherein the appearance reflects the instruction of the digital element of the one or more digital elements.

11. The method according to claim 10, wherein changing the appearance of the at least part of the digital movable item when moving the digital movable item at least partly to a position over the digital element of the one or more digital elements, comprises one or more of:
imitating, mimicking, copying, resembling, or representing the digital element of the one or more digital elements;
displaying symbols, text, and/or numbers;
changing to a smaller size;
changing colour; and/or
fading or becoming at least partly transparent.

12. The method according to claim 10, wherein the digital movable item comprises a cursor and wherein the digital element of the one or more digital elements comprises an icon or a digital button.

13. The method according to claim 10, wherein the method comprises changing the appearance of the at least part of the digital movable item, when a digital 3D model modification tool is selected and the digital movable item is moved within a predefined distance to an edge of the digital 3D model.

14. The method according to claim 10, wherein the method comprises revealing at least a part of the digital element of the one or more digital elements in the graphical user interface or displaying a graphical representation of at least a part of the digital element of the one or more digital elements in the graphical user interface, when the digital movable item is positioned over or moved towards the digital element of the one or more digital elements.

15. The method according to claim 10, wherein the instruction comprises:
changing the appearance of the digital movable item to represent the digital element of the one or more digital elements, to become smaller, or to become at least partly transparent, when the digital movable item is positioned over the digital element of the one or more digital elements in the graphical user interface; or
changing the appearance of at least a part of the digital movable item into a graphically dynamic appearance, when the digital movable item is positioned over the digital element of the one or more digital elements.
